(19) United States
(12) Patent Application Publication
(10) Pub. No.: US 2011/0289670 A1
(43) Pub. Date: Dec. 1, 2011

(54) BIOLOGICAL WASTE COLLECTION APPARATUS

(76) Inventor: Julie Root, Stow, OH (US)

(21) Appl. No.: 13/117,346

(22) Filed: May 27, 2011

Related U.S. Application Data
(60) Provisional application No. 61/348,786, filed on May 27, 2010.

(51) Int. Cl. A61G 9/00

(52) U.S. Cl. 4/450

(57) ABSTRACT

A biological waste collection apparatus may include a pad and a collection device. The pad may be suitable for being sat on by a patient and may include an absorbent material. The collection device may be attached to the pad and may include visible indicia that indicate the amount of biological waste matter within the collection device.

This application claims priority to U.S. Ser. No. 61/348,786, entitled BIOLOGICAL WASTE COLLECTION APPARATUS, filed May 27, 2010, which is incorporated herein by reference.

### I. BACKGROUND OF THE INVENTION

A. Field of Invention

This invention pertains to methods and apparatuses for the collection, measurement, visual inspection, and disposal of biological waste. More specifically, this invention relates to the collection, volume measurements, and visual inspection of urine and fecal matter.

B. Description of the Related Art

It is well known in the art to collect and measure the amount of urine or fecal matter for medical purposes. Measurement of the waste is more difficult if the patient is incapacitated such that a bed pan must be used for bowel movements or urinating.

It is known to empty the filled bed pan into a graduated container to measure the waste volumes. This method is inconvenient and prone to spills. These problems make this method inaccurate, unsanitary, and inefficient.

Known attempted solutions to the sanitation problem include disposable bed pans and measurement containers. The expense of these disposable devices leads some to attempt to disinfect and reuse the device. Incomplete disinfection leads to sanitation and health issues. Also the disposable devices still require the transfer of the waste from the collection device to a measurement device. Thus spillage and inaccuracies are still possible.

What is needed is an inexpensive, accurate, non-invasive, and disposable device to measure the volume of waste expelled.

### II. SUMMARY

According to one embodiment of this invention, a biological waste collection apparatus may comprise: a pad: (1) that is suitable for being sat on by an associated patient; (2) that comprises a first layer of absorbent material and a second layer of water resistant material; and, (3) that comprises an opening; and, a collection device: (1) that is attached to the pad; (2) that is accessible through the opening in the pad; (3) that is suitable to capture and hold associated biological waste matter as it is expelled by the associated patient; (3) that is at least partially transparent; and, (4) that comprises visible indicia that indicate the amount of associated biological waste matter within the collection device.

According to another embodiment of this invention, a biological waste collection apparatus may comprise: a pad: (1) that is suitable for being sat on by an associated patient; (2) that comprises an absorbent material; and, (3) that comprises an opening; and, a collection device: (1) that is attached to the pad; (2) that is accessible through the opening in the pad; (3) that is suitable to capture and hold associated biological waste matter as it is expelled by the associated patient; and, (3) that comprises visible indicia that indicate the amount of associated biological waste matter within the collection device.

According to yet another embodiment of this invention, a method may comprise the steps of: (A) providing a biological waste collection apparatus comprising: a pad; and, a collection device: (1) that is attached to the pad; and, (2) that comprises visible indicia; (B) using the biological waste collection apparatus to capture and hold biological waste matter as it is expelled by a patient; and, (C) determining the amount of biological waste in the collection device using the visible indicia.

Numerous benefits and advantages of the invention will become apparent to those skilled in the art to which it pertains upon a reading and understanding of the following detailed specification.

### III. BRIEF DESCRIPTION OF THE DRAWINGS

FIG. 1 shows a perspective view of an exemplary embodiment of the biological waste collection apparatus with the bottom side facing up.

FIG. 2 shows a perspective view of the biological waste collection apparatus shown in FIG. 1 with the top side facing up.

FIG. 3 is similar to FIG. 1 but showing the biological waste collection apparatus from a closer viewpoint.

FIG. 4 shows a perspective view of the biological waste collection apparatus with a close up of the waste retaining portion showing the indicia.

FIG. 5 shows a top view of the biological waste collection apparatus placed over a bed pan and ready to be used by a patient.

FIG. 6 is similar to FIG. 5 but shows the biological waste collection apparatus and bed pan from a perspective view

FIG. 7 shows the biological waste collection apparatus held upright to the light with the indicia visible.

FIG. 8 Shows the biological waste collection apparatus held upright and removed from the bed pan.

FIG. 9 shows a conventional bed pan with the top side facing up.

FIG. 10 shows a perspective view of the bed pan shown in FIG. 9.

FIG. 11 shows a conventional toilet.

FIG. 11 shows a conventional commode chair.

FIG. 13 shows another embodiment collection device.

FIG. 14 shows a close up view of the tear tab shown on the right hand side of FIG. 13.

### IV. DETAILED DESCRIPTION OF THE INVENTION

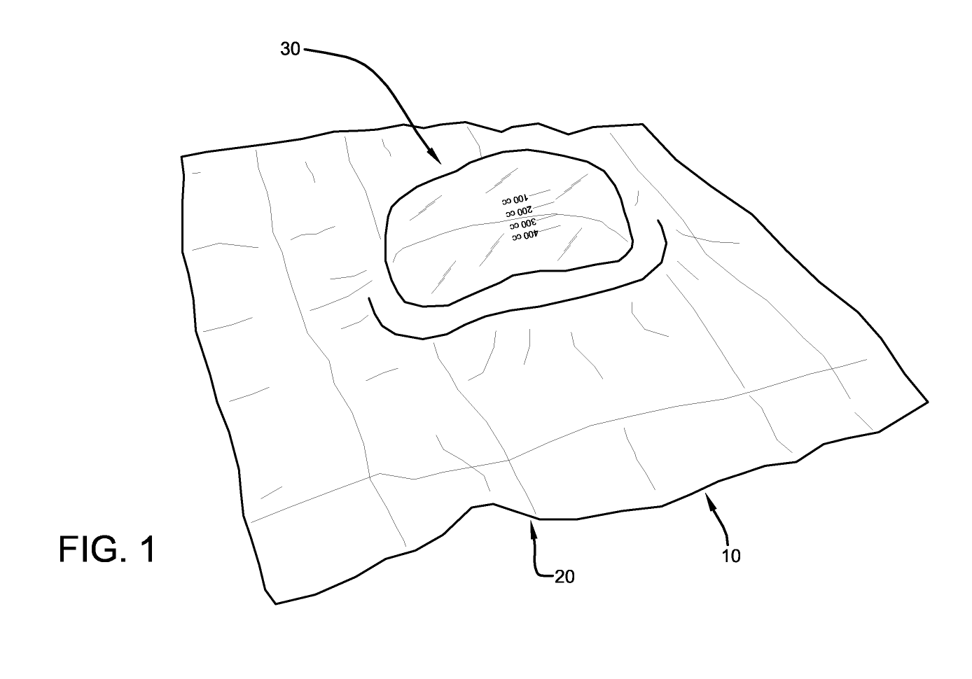

Referring now to the drawings wherein the showings are for purposes of illustrating embodiments of the invention only and not for purposes of limiting the same, and wherein like reference numerals are understood to refer to like components, FIG. 1 shows a biological waste collection apparatus 10 according to one embodiment of the present invention. The biological waste collection apparatus 10 may include a pad 20 and a collection device 30.

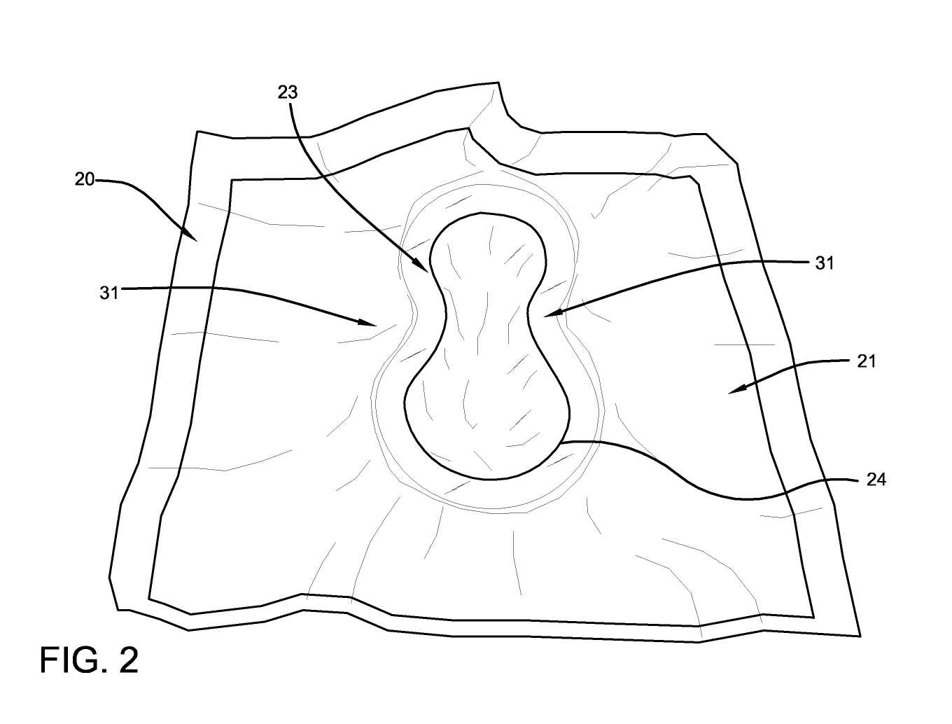

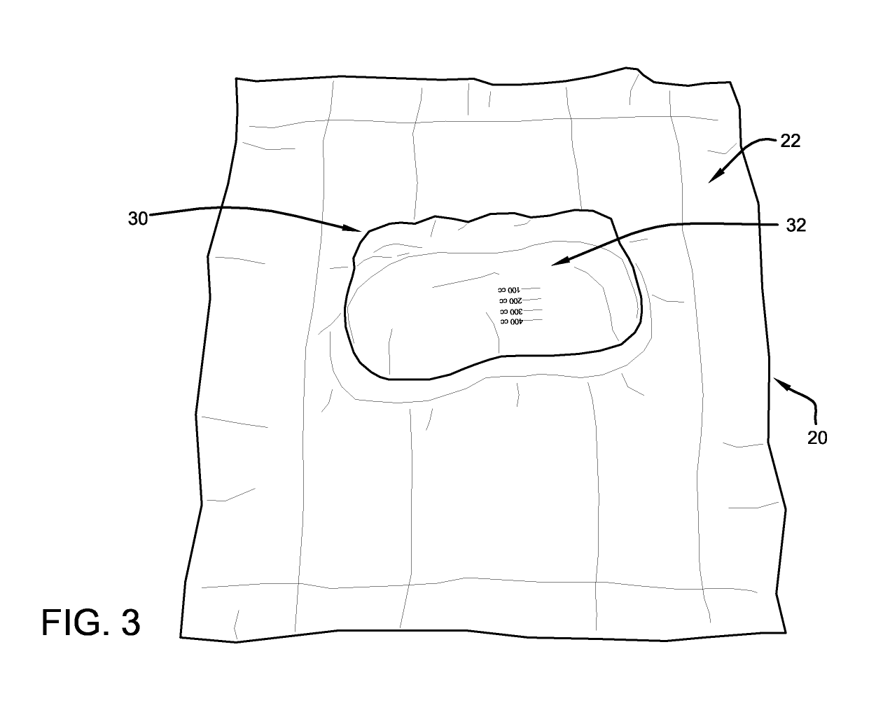

Referring to FIGS. 1-3, the pad 20 may be suitable for being sat on by an patient for use. The pad 20 may have an opening 23 located, in one embodiment, substantially in the center of the pad 20. The opening 23 may be sized to permit access to the collection device 30. The pad 20 may be formed in any manner and of any material chosen with the sound judgment of a person of skill in the art. In one embodiment, the pad 20 may be formed in layers. In one specific embodiment, the pad 20 may have a first layer 21 of absorbent material and a second layer 22 of water resistant material. Thus, the pad 20 may have a side that absorbs fluid and a side that prevents fluid from passing through. The first layer 21 may be made from a soft, thick material which would be comfortable for the patient to sit on. The second layer 22 may have a slip resistant surface so that the biological waste collection apparatus 10 may not slip or slide when the patient is seated upon it. The layers may be integrally formed or formed separately and joined together to comprise the pad 20.

Referring still to FIGS. 1-3, the pad 20 may be made from material that can be readily disposed of with normal household waste. In one non-limiting embodiment, the pad 20 is formed of Chux. The pad 20 may be sized and shaped such that it covers a large enough area to contain any biological waste matter when a patient must relieve him or herself and also be firmly retained by the patient when seated upon the pad 20. The pad 20 may have an attachment surface 24 used to attached the pad 20 to the collection device 30. For the embodiment shown, the attachment surface 24 is located around the perimeter of the opening 23.

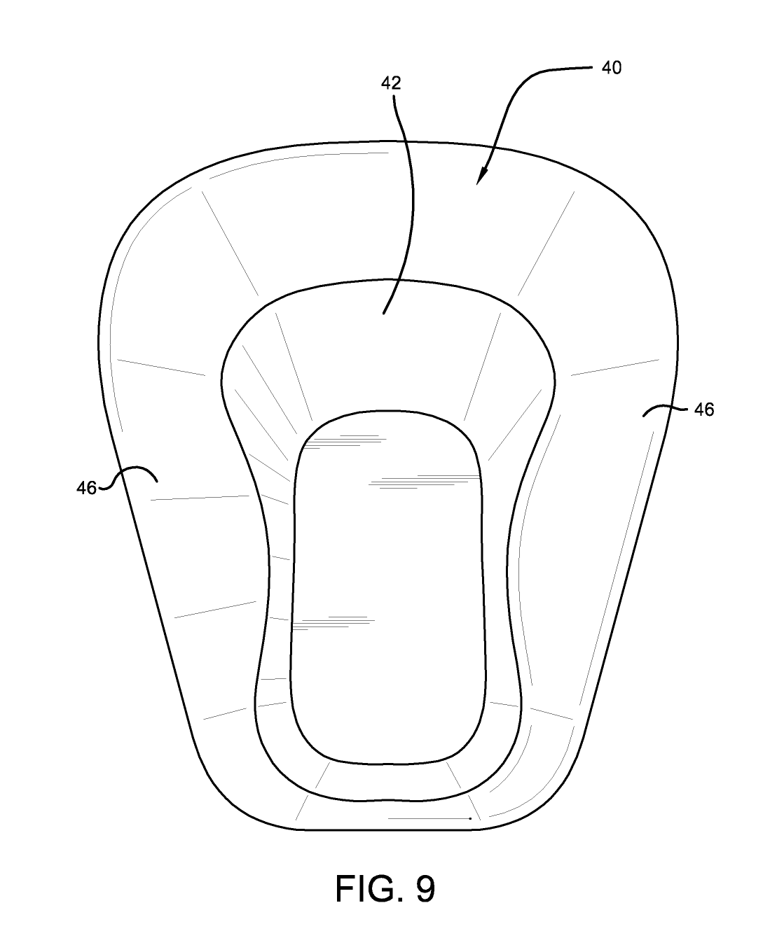

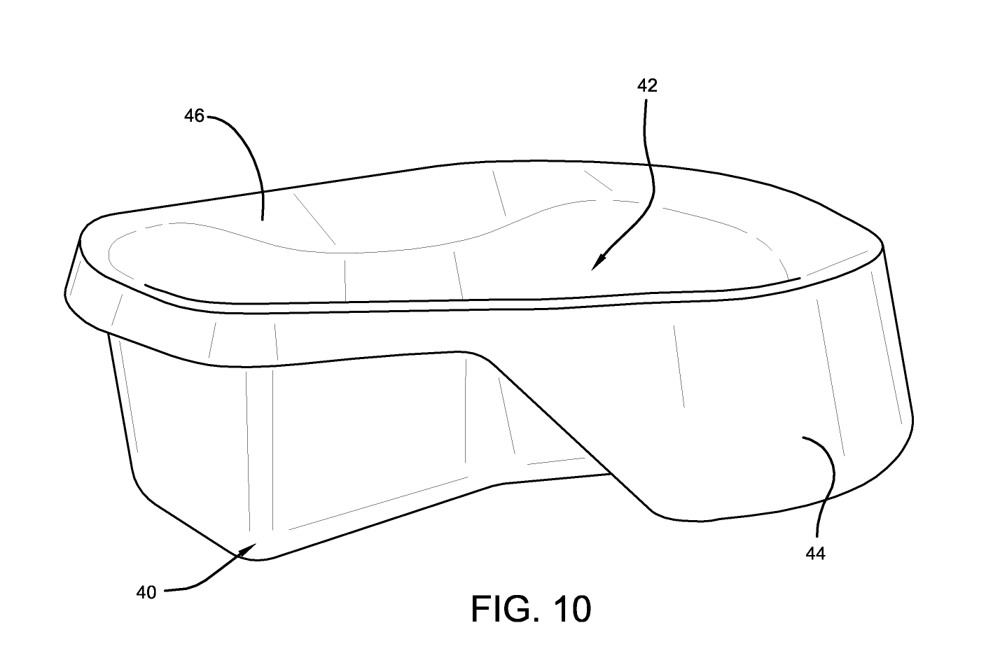

Referring to FIGS. 1-5, the collection device 30 may be suitable to capture and hold biological waste matter as it is expelled by a patient. It may be sized to capture the volume of biological waste matter when a patient must relieve himself or herself. In one embodiment, the collection device 30 may be shaped to fit down into conventional waste receiving devices such as a toilet 50 (shown in FIGURE) or a bed pan 40 (shown in FIGS. 9-10) and at the same time not interfere with the patient's use of the collection device 30. The collection device 30 may have an attachment surface 31 for use in attaching to the pad 24. In one embodiment, the attachment surface 31 of the collection device 30 contacts and attaches to the attachment surface 24 of the pad 20. For the embodiment shown, the edges of the collection device 30 are inserted through the opening 23 and then folded down so the attachment surfaces 24, 31 come into contact. The attachment surfaces 24, 31 may be connected in any manner that is chosen with the sound judgment of a person of skill in the art. Non-limiting examples of ways to attach the attachment surfaces 24, 31 together include adhesives (including tape), affixing with heat, and stitching.

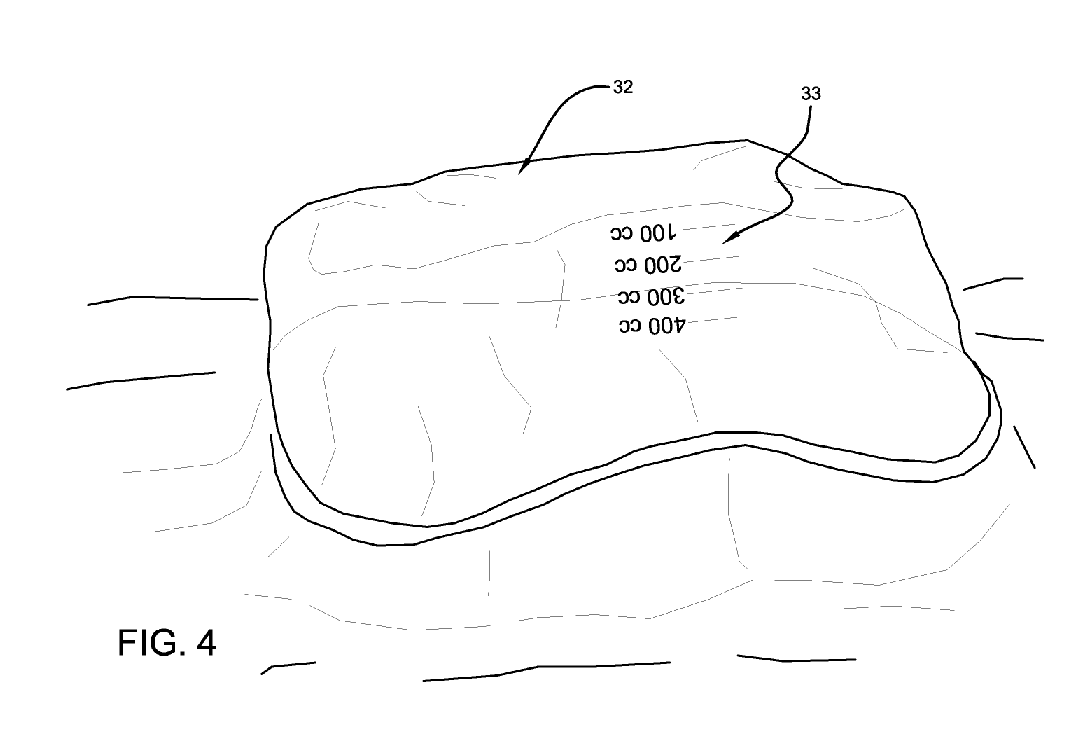

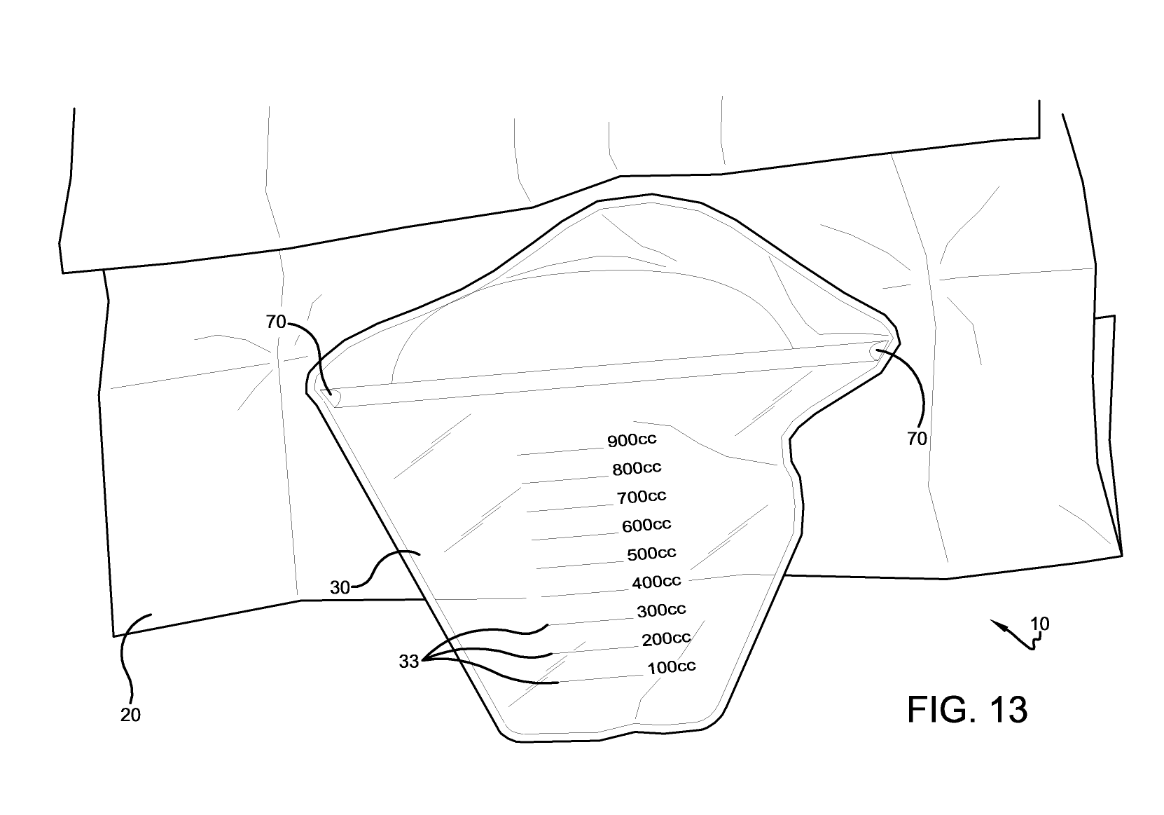

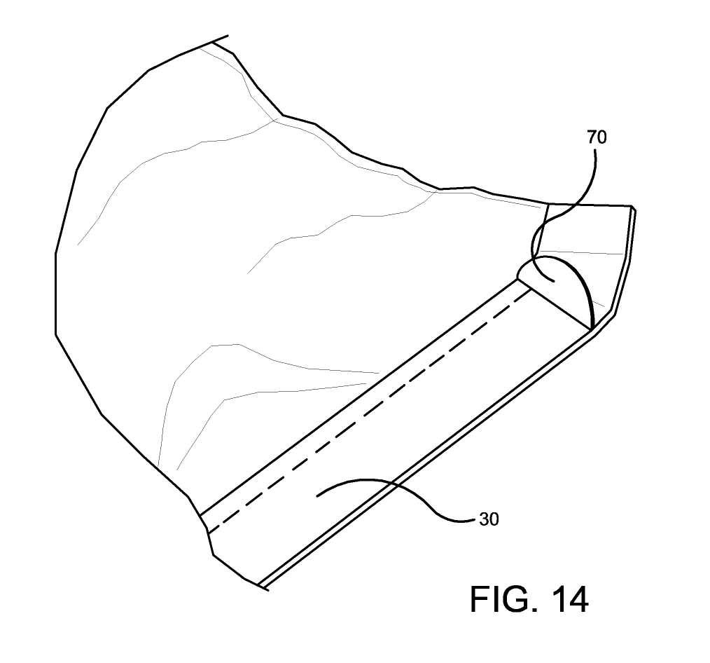

Referring to FIGS. 4 and 7-8, the collection device 30 may be completely or partially transparent. In one embodiment, the collection device 30 has one or more windows that are transparent. As shown in FIG. 4, the collection device 30 may also have visible indicia 33 graduated to permit the volume measurement of the biological waste matter. The collection device 30 may be integrally formed or formed separately and joined together with the pad 20 to comprise the biological waste collection apparatus 10. In one embodiment, the collection device 30 is formed of a plastic. In one embodiment, the entire biological waste collection apparatus 10 is formed of material that is appropriate for disposal with normal household waste. FIGS. 13 and 14 show another embodiment where a pair of tear tabs 70, 70 are positioned on the collection device 30. The tear tab 70 may be used to permit the collection apparatus 30 to be opened so that the biological waste matter within the collection apparatus can be disposed of. In another embodiment, only one tear tab 70 is used.

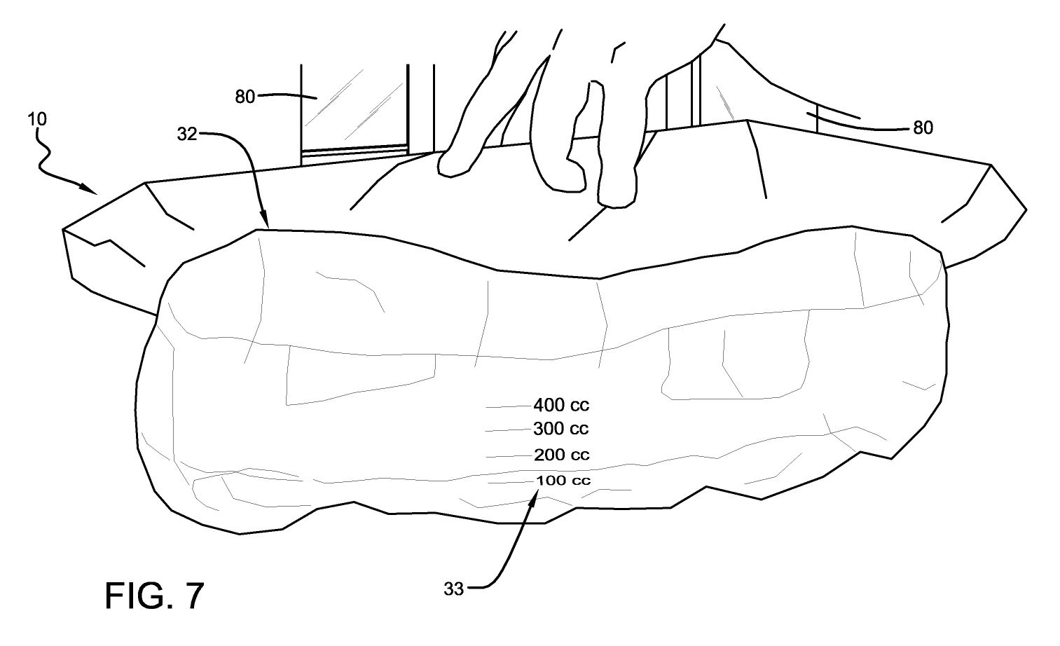

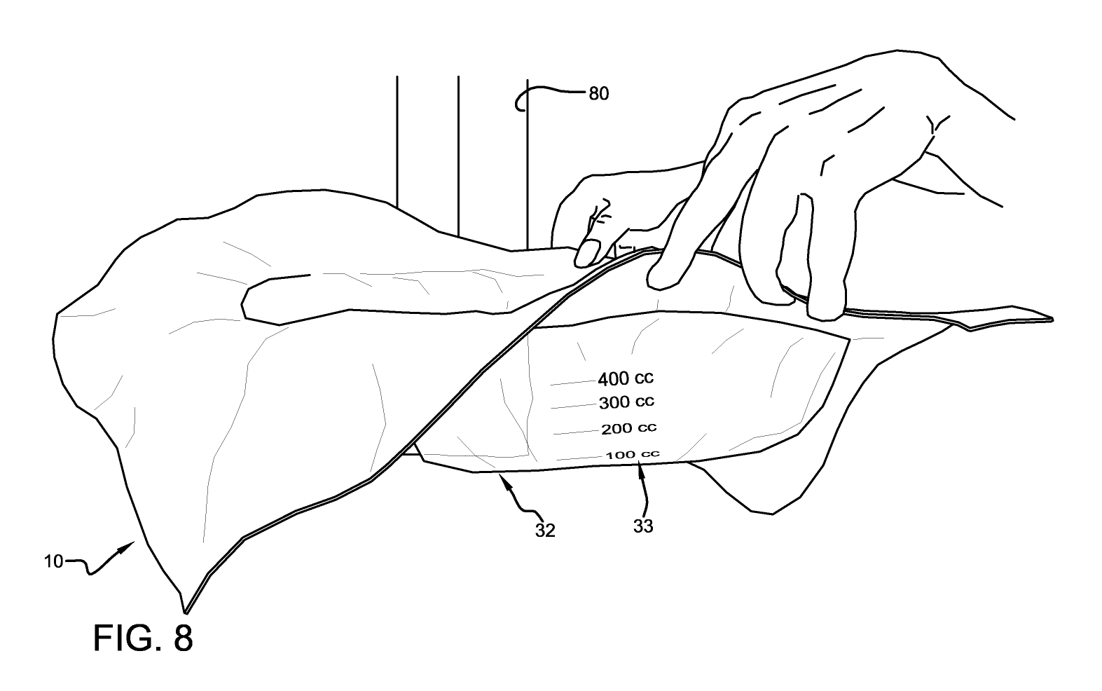

Referring to FIGS. 7-8, after the patient has relieved him or herself, the biological waste collection apparatus 10 may be held in front of a light source 80 such as an electrical light or a window. The viewer can then compare the level of biological waste to the indicia 33 and thereby determine the amount of biological waste in the collection device 30. At the same time, the visual qualities of the biological waste may be observed through the transparent collection device 30. If need be, samples from the biological waste may be collected and the biological waste collection apparatus 10 may be disposed of.

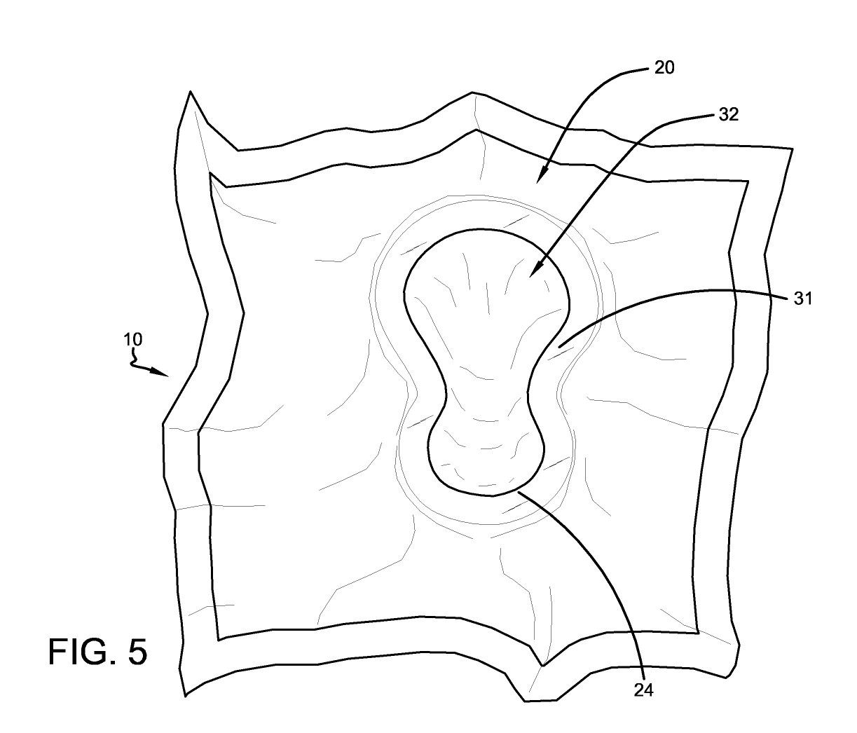

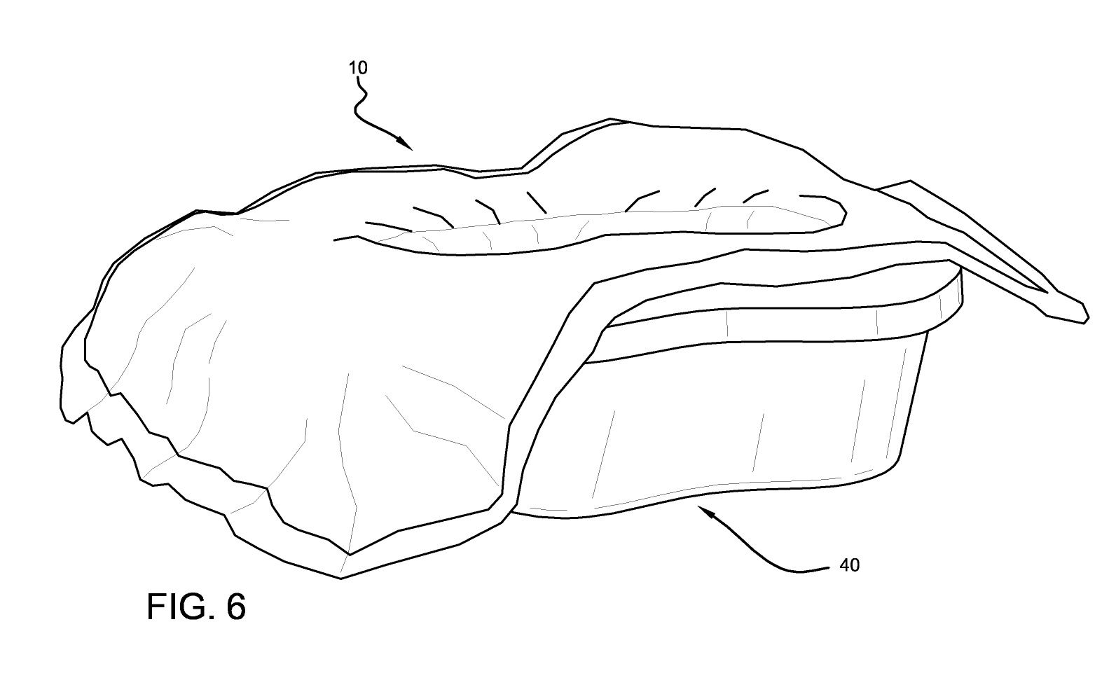

Referring to FIGS. 5-6 and 9-10, in one embodiment, the biological waste collection apparatus 10 may be used with a conventional bed pan 40. The bed pan 40 may have a holding chamber 42 and a sidewall 44 that extends upwardly to a top surface 46. The collection device 30 may then be positioned within the holding chamber 42 of the bed pan 40 with the pad 20 positioned onto the top surface 46. The patient can then be positioned onto the pad 20. The first layer 21 of absorbent material may be facing up, toward the patient. The pad 20 may be spread out such that it covers a large enough area to contain any waste matter that may miss the bed pan 40. When covering the bed pan 40, the pad 20 may also provide a more comfortable seating area for the patient. In this process the bed pan 40 has not been contaminated by the waste matter and thus it may be reused in a sanitary manner.

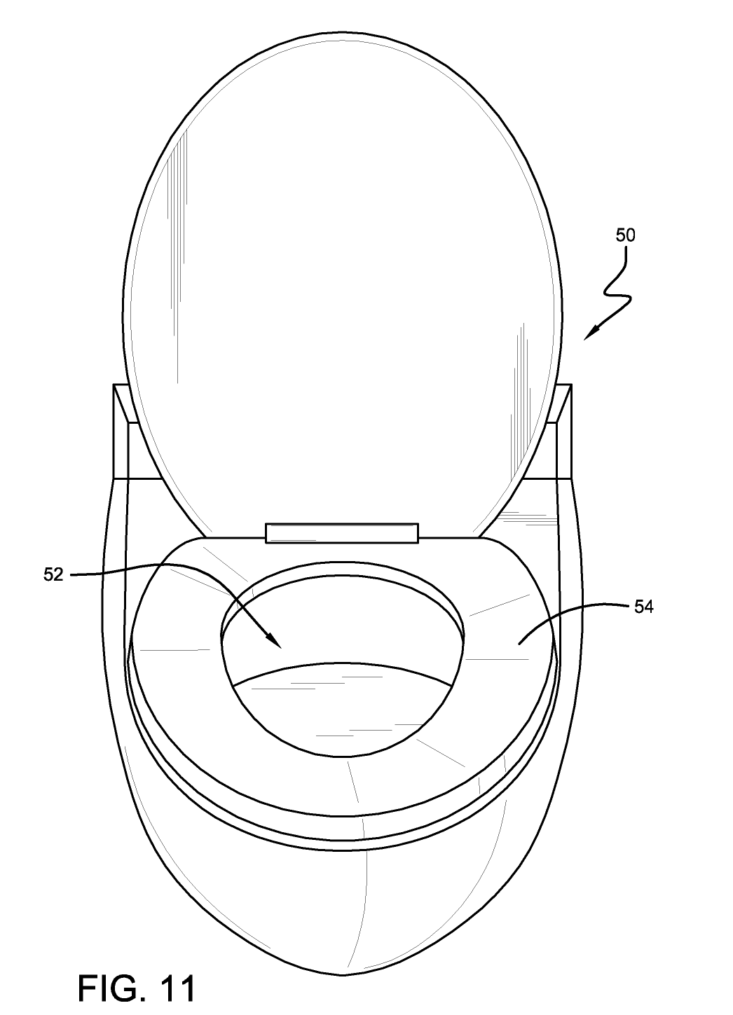

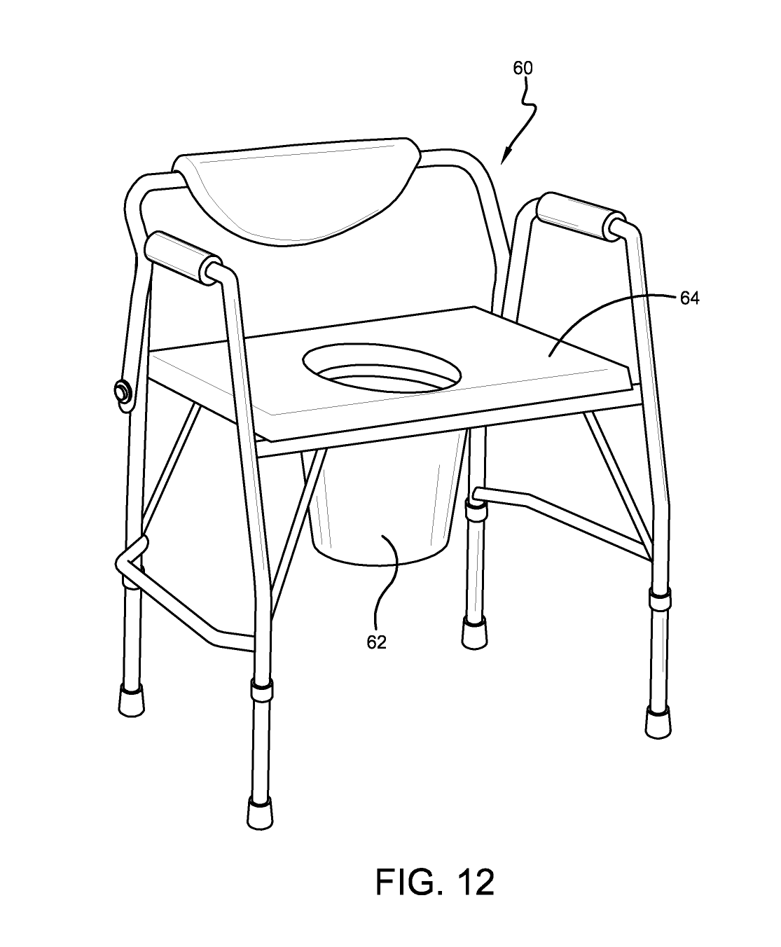

Referring to FIGS. 1-4 and 11, in another embodiment, the biological waste collection apparatus 10 may be used with a conventional toilet 50. The toilet may have a holding chamber 52 and a toilet seat 54. The collection device 30 may then be positioned within the holding chamber 52 of the toilet 50 with the pad 20 positioned onto the toilet seat 54. The patient can then be positioned onto the pad 20 and the biological waste collection apparatus 10 can be used as described above.

Referring to FIGS. 1-4 and 12, in yet another embodiment, the biological waste collection apparatus 10 may be used with a conventional commode chair 60. The collection device 30 may be positioned within the holding chamber 62 of the commode chair with the pad 20 positioned onto the seat 64. The patient can then be positioned onto the pad 20 and the biological waste collection apparatus 10 can be used as described above.

Referring to FIGS. 1-4, in still another embodiment, the biological waste collection apparatus 10 can be used as an aid in cleaning up after the patient has urinated or passed excrement. The absorbent layer 21 of the pad 20 may be used to wipe the patient's buttock, upper legs and lower torso areas.

Referring again to FIGS. 1-4, in another embodiment, the biological waste collection apparatus 10 may be used as an undergarment. The pad 20 may be shaped to fit and cover from the patient's front waistline down and between their legs, positioned to cover the genital area, and wrapped back up to cover the patient's buttocks, and finishing near the patient's rear waistline. The absorbent side of the pad 20 may be place against the patient's skin and the collection device 30 may be positioned to receive urine or fecal matter expelled by the patient. Elastic material may be added to the biological waste collection apparatus 10 to aid in obtaining a snug fit around the patient's waist and legs.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A biological waste collection apparatus comprising:
a pad: (1) that is suitable for being sat on by an associated patient; (2) that comprises a first layer of absorbent material and a second layer of water resistant material; and, (3) that comprises an opening; and,
a collection device: (1) that is attached to the pad; (2) that is accessible through the opening in the pad; (3) that is suitable to capture and hold associated biological waste matter as it is expelled by the associated patient; (3) that is at least partially transparent; and, (4) that comprises visible indicia that indicate the amount of associated biological waste matter within the collection device.

2. The biological waste collection apparatus of claim 1 wherein the biological waste collection apparatus is disposable with normal household waste.

3. The biological waste collection apparatus of claim 2 wherein:
the pad comprises a first attachment surface around the perimeter of the opening;
the collection device comprises a second attachment surface; and,
the first attachment surface is attached to the second attachment surface with one of: an adhesive and stitching.

4. The biological waste collection apparatus of claim 3 wherein the collection device is formed of a plastic.

5. The biological waste collection apparatus of claim 4 wherein the biological waste collection apparatus is sized and shaped so that the collection device fits down into an associated conventional toilet and the pad rests on an associated conventional toilet seat.

6. A biological waste collection apparatus comprising:
a pad: (1) that is suitable for being sat on by an associated patient; (2) that comprises an absorbent material; and, (3) that comprises an opening; and,
a collection device: (1) that is attached to the pad; (2) that is accessible through the opening in the pad; (3) that is suitable to capture and hold associated biological waste matter as it is expelled by the associated patient; and, (3) that comprises visible indicia that indicate the amount of associated biological waste matter within the collection device.

7. The biological waste collection apparatus of claim 6 wherein the pad comprises:
a first layer of absorbent material; and,
a second layer of water resistant material.

8. The biological waste collection apparatus of claim 7 wherein the second layer comprises a slip resistant surface.

9. The biological waste collection apparatus of claim 8 wherein the pad is formed of Chux.

10. The biological waste collection apparatus of claim 6 wherein the biological waste collection apparatus is disposable with normal household waste.

11. The biological waste collection apparatus of claim 6 wherein:
the pad comprises a first attachment surface around the perimeter of the opening;
the collection device comprises a second attachment surface; and,
the first attachment surface is attached to the second attachment surface with one of an adhesive and stitching.

12. The biological waste collection apparatus of claim 6 wherein the collection device is at least partially transparent.

13. The biological waste collection apparatus of claim 12 wherein the collection device is formed of a plastic.

14. The biological waste collection apparatus of claim 6 wherein the biological waste collection apparatus is sized and shaped so that the collection device fits down into an associated conventional toilet and the pad rests on an associated conventional toilet seat.

15. A method comprising the steps of:
(A) providing a biological waste collection apparatus comprising: a pad; and, a collection device: (1) that is attached to the pad; and, (2) that comprises visible indicia;
(B) using the biological waste collection apparatus to capture and hold biological waste matter as it is expelled by a patient; and,
(C) determining the amount of biological waste in the collection device using the visible indicia.

16. The method of claim 15 wherein after step (C) the method comprises the step of:
disposing of the biological waste collection apparatus with normal household waste.

17. The method of claim 15 wherein:
step (A) comprises the step of: providing the collection device to be at least partially transparent; and,
step (C) comprises the steps of: holding the collection device in front of a light source; and, comparing the level of biological waste to the indicia.

18. The method of claim 15 wherein:
after step (A) and before step (B) the method comprises the steps of:
providing a bed pan comprising a holding chamber and a sidewall that extends upwardly to a top surface;
positioning the collection device within the holding chamber of the bed pan; and,
positioning the pad onto the top surface;
positioning the patient onto the pad; and,
after step (B) and before step (C) the method comprises the step of:
removing the biological waste collection apparatus from the bed pan.

19. The method of claim 15 wherein:
after step (A) and before step (B) the method comprises the steps of
providing a toilet comprising a holding chamber and a toilet seat;
positioning the collection device within the holding chamber; and,
positioning the pad onto the toilet seat;
positioning the patient onto the pad; and,
after step (B) and before step (C) the method comprises the step of:
removing the biological waste collection apparatus from the toilet.

20. The method of claim 15 wherein:
after step (A) and before step (B) the method comprises the steps of:
placing the biological waste collection apparatus onto the patient as an undergarment; and,
after step (B) and before step (C) the method comprises the step of:
removing the biological waste collection apparatus from the patient.
